(19) United States
(12) Patent Application Publication
(10) Pub. No.: US 2025/0114739 A1
(43) Pub. Date: Apr. 10, 2025

(54) CARBON DIOXIDE CAPTURE SYSTEM

(71) Applicant: NANOTECHCERAMICS CO., LTD., Busan (KR)

(72) Inventors: Sang Ok JEONG, Busan (KR); Jong Min LIM, Yangsan-si (KR); Min Su LEE, Busan (KR)

(21) Appl. No.: 18/312,452

(22) Filed: May 4, 2023

(30) Foreign Application Priority Data
Dec. 27, 2022 (KR) 10-2022-0185307

(51) Int. Cl. B01D 53/14; B01D 53/18; B01D 53/92

(52) U.S. Cl. CPC B01D 53/1475; B01D 53/1493; B01D 53/185; B01D 53/92; B01D 2252/1035; B01D 2257/504; B01D 2258/01; B01D 2259/4566

(57) ABSTRACT

Disclosed is a carbon dioxide reduction system providing the advantage of efficiently capturing and removing the carbon dioxide contained in the exhaust gas, thereby significantly reducing the carbon dioxide emitted into the atmosphere.
Also disclosed is a carbon dioxide reduction system providing the advantage of not requiring a separate sealed container storing the captured carbon dioxide, resulting in improved space utilization for space-limited environment and improved energy efficiency.

This application claims priority to Korean Patent Application No. 10-2022-0185307, filed on Dec. 27, 2022 in the Korean Intellectual Property Office, the disclosures of which are incorporated by reference herein in their entireties.

### TECHNICAL FIELD

The present invention relates to a carbon dioxide reduction system, and more particularly to a carbon dioxide reduction system capable of discharging and storing carbon dioxide emitted directly into the atmosphere from a combustion engine or separated/purified carbon dioxide in a safe form into the ocean.

### BACKGROUND OF THE INVENTION

With the development of industry, the problem of global warming due to the increasing concentration of carbon dioxide in the atmosphere is emerging, and the biggest cause of the increasing concentration of carbon dioxide in the atmosphere is the use of fossil fuels such as coal, oil, and liquefied natural gas used in the energy industry.

Since the beginning of industrialization in the early 19th century, the concentration of greenhouse gases such as carbon dioxide (CO₂), methane (CH₄), hydrogen sulfide (H₂S), and carbonyl sulfide (COS) has increased in the atmosphere and has increased rapidly since the mid-20th century.

The acceleration of global warming due to the increase of these greenhouse gases has led to stricter regulations on their emission and treatment. Since the United Nations Conference on Environment and Development held in Rio de Janeiro, Brazil in June 1992, international attention to global warming has been gradually increasing, and developed countries, including the United States and Japan, have agreed to reduce global greenhouse gas emissions by 5.2% in 2010 compared to 1990 levels, leading to international consensus on greenhouse gas reduction measures. In particular, the separation of carbon dioxide, which accounts for about 80% of the greenhouse gases that cause global warming, has become a more important issue.

Particularly, much attention has been paid to the separation, capture, and storage of carbon dioxide generated in confined spaces such as ships and offshore plants. Currently, there are two main types of carbon dioxide reduction methods for ships and offshore plants: first, when utilizing seawater for SOx reduction, some carbon dioxide can be dissolved in seawater, and there are closed and open types. In general, seawater after absorption is discharged back into the ocean when certain conditions (pH and discharge standards) are met. In other words, in this case, carbon dioxide is temporarily captured physically rather than chemically, so the permanent storage effect is small, and there are limitations that require quantitative verification.

There is also a method of capturing carbon dioxide through the chemical binding of certain amine-based absorbers, which has the advantage of high capture efficiency. However, separating, purifying, liquefying, and storing carbon dioxide that is strongly bound to chemical absorbers requires a large amount of heating and additional refrigeration, which is energy intensive and has many limitations given the limited space available.

### PRIOR ART DOCUMENTS

### Patent Documents

Korean Patent Registration 10-1201426,

Korean Patent Registration 10-1159211, and

Korean Patent Publication 10-2010-0124547

### PROBLEM TO BE SOLVED

The problem that the present invention seeks to solve is to provide a carbon dioxide abatement system that can efficiently store and discharge air pollutants contained in exhaust emissions from combustion engines, particularly the carbon dioxide component that is difficult to remove in conventional exhaust treatment systems, into the ocean.

### SUMMARY

To solve the above-mentioned problems, an aspect of a carbon dioxide reduction system for capturing and removing carbon dioxide, installed on a ship or an offshore plant, to be connected to an exhaust outlet of a combustion engine discharging exhaust gas comprises an exhaust gas inlet configured to receive the exhaust gas discharged from the combustion engine; a scrubber wash water generator configured to store ceramic particles containing oxides, hydroxides, or carbonates of alkali metals, and to convert seawater into scrubber wash water through a reaction with the ceramic particles; a carbon dioxide scrubber configured to receive the exhaust gas from the exhaust gas inlet and to reduce carbon dioxide; and a scrubber wash water supply configured to supply scrubber wash water received from the scrubber wash water generator to the carbon dioxide scrubber to make the scrubber wash water and the exhast gas contact.

The scrubber wash water supply may be further configured to be installed inside the carbon dioxide scrubber on an upstream side of the carbon dioxide scrubber and to spray the scrubber wash water in such a way that it is sprayed through a spray nozzle.

The carbon dioxide reduction system may further comprise a byproduct storage tank configured to collect and to store reaction byproducts discharged from the carbon dioxide scrubber to enhance the efficiency of the reduction.

The ceramic particles may comprise at least one selected from the group consisting of CaCO₃, MgCO₃, CaO, MgO, Ca(OH)₂, and Mg(OH)₂.

The ceramic particles have an average particle size of 1 to 5,000 μm.

The scrubber wash water generator may further comprise an accelerator inlet configured to receive an accelerator comprising an oxide, hydroxide, or carbon oxide of an alkali metal.

The carbon dioxide reduction system may further comprise a ceramic particle storage configured to store the ceramic particles, and to be connected to the scrubber wash water generator such that the stored ceramic particles are periodically fed into the scrubber wash water generator.

The carbon dioxide reduction system may further comprise a byproduct outlet configured to be connected to the byproduct storage tank, and to discharge the reaction byproduct into the ocean.

The scrubber wash water may have a pH of between pH 9.5 and 14.0.

### Technical Advantage

The carbon dioxide reduction system of the present invention has the effect of efficiently capturing and removing the carbon dioxide contained in the exhaust gas, thereby significantly reducing the carbon dioxide emitted into the atmosphere. In addition, the carbon dioxide reduction system of the present invention does not require storing the captured carbon dioxide in a separate sealed container, which can improve space utilization in cases where space is limited, and has the effect of saving energy.

### BRIEF DESCRIPTION OF THE DRAWINGS

FIG. 1 describes a carbon dioxide reduction system according to an embodiment.

FIG. 2 describes a carbon dioxide reduction system according to the other embodiment.

FIG. 3 describes a carbon dioxide reduction system for ships, according to still another embodiment.

### DETAILED DESCRIPTION OF EXEMPLARY EMBODIMENTS

Hereinafter, with reference to the accompanying drawings, embodiments of the present invention will be described in detail so that one having ordinary knowledge in the technical field to which the present invention belongs can readily practice it.

As mentioned above, the carbon dioxide removal and reduction systems applied to conventional ships had limitations such as low carbon dioxide removal efficiency and the need to store liquefied carbon dioxide in separate sealed containers, making it difficult to install and operate in ships or offshore plants with limited space.

According to the present invention, a carbon dioxide reduction system for capturing and removing carbon dioxide, installed on a ship or an offshore plant, to be connected to an exhaust outlet of a combustion engine discharging exhaust gas comprises an exhaust gas inlet configured to receive the exhaust gas discharged from the combustion engine; a scrubber wash water generator configured to store ceramic particles containing oxides, hydroxides, or carbonates of alkali metals, and to convert seawater into scrubber wash water through a reaction with the ceramic particles; a carbon dioxide scrubber configured to receive the exhaust gas from the exhaust gas inlet and to reduce carbon dioxide; and a scrubber wash water supply configured to supply scrubber wash water received from the scrubber wash water generator to the carbon dioxide scrubber to make the scrubber wash water and the exhast gas contact.

Accordingly, the present invention generates scrubber wash water using ceramic particles containing oxides, hydroxides, or carbon oxides of seawater and alkaline earth metals, and by effectively capturing and removing carbon dioxide using the scrubber wash water, carbon dioxide emitted to the atmosphere can be significantly reduced. In addition, it is not necessary to store the captured carbon dioxide in a separate sealed container, so that space can be utilized in cases where space is limited, and energy can be saved.

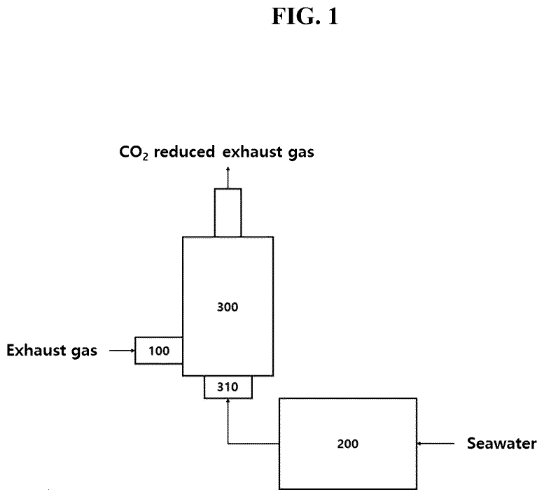

FIG. 1 describes a carbon dioxide reduction system according to an embodiment. Referring to FIG. 1, the carbon dioxide reduction system comprises an exhaust gas inlet 100 configured to receive the exhaust gas discharged from the combustion engine; a scrubber wash water generator 200 configured to store ceramic particles containing oxides, hydroxides, or carbonates of alkali metals, and to convert seawater into scrubber wash water through a reaction with the ceramic particles; a carbon dioxide scrubber 300 configured to receive the exhaust gas from the exhaust gas inlet 100 and to reduce carbon dioxide; and a scrubber wash water supply 310 configured to supply scrubber wash water received from the scrubber wash water generator 200 to the carbon dioxide scrubber to make the scrubber wash water and the exhast gas contact.

The exhaust gas inlet 100 receives exhaust gas from the combustion engine. The incoming exhaust gas is fed to the carbon dioxide scrubber 300, as described later.

In the scrubber wash water generator 200, ceramic particles containing oxides, hydroxides, or carbon oxides of alkaline earth metals are stored, and as the incoming seawater passes through said ceramic particles, it is converted into alkaline scrubber wash water through a reaction.

By utilizing seawater to generate scrubber wash water in this manner, the present invention can efficiently capture and remove carbon dioxide contained in exhaust gases. Furthermore, as will be described later, the reaction by-products can be discharged immediately into the sea without the need to continuously store or transport them, allowing for effective use of the limited space and reducing energy requirements.

In the early 2000s, the Accelerated Weathering of Limestone (AWL) technology was first proposed as an alternative to underground storage, which uses limestone neutralization reactions to store CO₂ in the ocean. It is described as a technology that has the potential to reduce about 10 to 20 percent of carbon dioxide emissions from large-scale emitters and can capture carbon dioxide while increasing the alkalinity of the ocean to prevent ocean acidification.

The amount of atmospheric carbon dioxide that can be stored as dissolved inorganic carbon per unit volume of seawater by the conventional arts is about 120 mg/L (120 ppm), and about 240 mg/L (about 240 ppm) if AWL is utilized. The amount of dissolved inorganic carbon that can be stored in pure seawater at 1 m³ is approximately 8.7 g/Ton and 17.4 g/Ton with AWL technology. Seawater, considered a semi-permanent resource, is an excellent technology for reducing atmospheric carbon dioxide that contributes to global warming, but it is insufficient to capture the entire amount of carbon dioxide emitted into the atmosphere annually by the world.

The oxides, hydroxides and carbon oxides of alkaline earth metals covered by the present invention are used in our preferred embodiment of the carbon dioxide reduction system to store carbon dioxide in the form of dissolved inorganic carbon (carbonate, bicarbonate) in seawater in a more effective and stable manner, using by-products of industrial processes or easily obtainable materials from everyday life. The single or more ceramic particles comprising the applied alkaline earth metal oxides, hydroxides and carbonates may be one or more selected from the group consisting of CaCO₃, MgCO₃, CaO, MgO, Ca(OH)₂ and Mg(OH)₂. Though the amount can vary depending on the type of alkaline earth metal applied, it was confirmed through the Inorganic Carbon (IC) content measured by the Total Organic Carbon Analyzer (TOC-L, Shimadzu) that using this invention allows for storage at 5 to 100 times (600 to 12,000 ppm) compared to seawater and 2.5 to 50 times (600 to 12,000 ppm) compared to AWL at 2 wt %. This indicates that up to 12 kg of carbon dioxide can be stored in 1 m³ of seawater.

When seawater passes through ceramic particles containing oxides, hydroxides, or carbon oxides of alkaline earth metals, though the pH of the resulting scrubber wash water can vary depending on the type of alkaline earth metal used, it is typically between pH 9.5 and 14.0. Different types of alkaline earth metals have different alkalinity and pH activation in seawater, and to induce a faster and more stable gas-liquid reaction with carbon dioxide, an accelerator comprising an oxide, hydroxide, or carbon oxide of an alkaline earth metal may be additionally used.

The use of an accelerator comprising an oxide, hydroxide, or carbon oxide of an alkaline earth metal can increase the alkalinity of seawater at a faster rate than the use of ceramic particles comprising an oxide, hydroxide, or carbon oxide of an alkaline earth metal alone, thereby allowing carbon dioxide in the scrubber 300 to be more effectively dissolved in the scrubber wash water, thereby effectively capturing and removing carbon dioxide contained in the exhaust gas.

Ceramic particles activated by the addition of these accelerators can reliably increase the pH of seawater by more than 1.5 to 2 times compared to ceramic particles containing oxides, hydroxides, or carbonates of alkaline earth metals alone. This is an amount that can be stored more than 200 times higher than seawater (24,000 ppm) and more than 100 times higher than AWL (24,000 ppm).

Further, the size of the ceramic particles may be determined according to the concentration of carbon dioxide (CO₂) in the exhaust gas, the amount of carbon dioxide (CO₂) storage per hour, and it may be desirable to have a smaller size of the particles to increase the alkaline activity of the seawater, and specifically, the average particle diameter of the ceramic particles may be from 1 to 5,000 μm. In this case, the alkali ion supply time to the seawater is short, which can reduce the process cost by not requiring a large storage space for the reaction, and benefiting from the continuous pH restoration, the acid-base reaction with carbon dioxide is effectively performed, resulting in higher carbon dioxide capture efficiency and improved process efficiency.

If the average particle diameter of the ceramic particles is below the above range, all of the ceramic particles will be eluted in a short period of time, resulting in an excessively short replacement cycle. Also, if the average particle diameter of the ceramic particles exceeds the above range, the supply of alkali ions to the seawater will take a long time, necessitating a larger storage space for the reaction.

In some cases, the system may further comprise a ceramic particle storage associated with the scrubber wash water generator 200, so that the ceramic particles are stored, and the stored ceramic particles are periodically fed into the scrubber wash water generator 200.

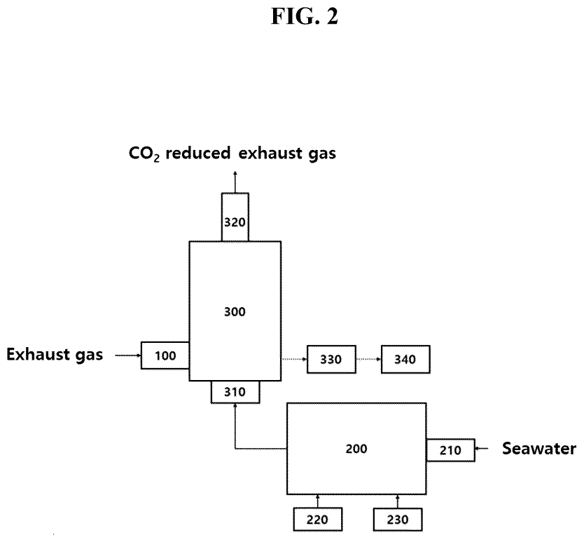

FIG. 2 describes a carbon dioxide reduction system according to the other embodiment. Referring to FIG. 2, the present invention may further comprise a scrubber wash water generator 200, and a seawater inlet 210 connected to the scrubber wash water generator 200 and into which seawater is introduced and supplied. In some cases, it may further include a ceramic particle storage 220 connected to the scrubber wash water generator 200 and periodically supplying ceramic particles to the scrubber wash water generator 200. It may further include an accelerator inlet 230 connected to the scrubber wash water generator 200 for injecting an accelerator comprising an oxide, hydroxide, or carbon oxide of an alkali metal into the scrubber wash water generator 200.

When an accelerator comprising oxides, hydroxides, or carbon oxides of alkali metals is introduced into the scrubber wash water generator 200 via the accelerator inlet 230, the pH and alkalinity of the seawater can be improved at a faster rate than when ceramic particles comprising oxides, hydroxides, or carbon oxides of alkaline earth metals are used alone. Due to the continuous capture of carbon dioxide, the pH of the seawater converges to 7.4 to 8.1, which maximizes the amount of dissolved inorganic carbon (the stored amount of carbonate ions and bicarbonate ions) that can be stored in the seawater.

The carbon dioxide scrubber 300 receives exhaust gas entering through the exhaust gas inlet 100 and reduces carbon dioxide in the exhaust gas by capturing and removing carbon dioxide contained in the exhaust gas.

Furthermore, the scrubber wash water supply 310 supplies scrubber wash water generated by the scrubber wash water generator 200 into the interior of the carbon dioxide scrubber 300 so that it is in gas-liquid contact with the exhaust gas.

Referring to FIG. 2, the scrubber wash water is generated using seawater in the scrubber wash water generator 200, and is supplied to the carbon dioxide scrubber 300 through the scrubber wash water supply 310. In addition, exhaust gas is supplied to the carbon dioxide scrubber 300 through the exhaust gas inlet 100. This allows the scrubber wash water and the exhaust gas to come into gas-liquid contact to remove various air pollutants including carbon dioxide contained in the exhaust gas.

Specifically, when carbon dioxide is dissolved in water, the chemical reaction is shown in Equation 1 and Equation 2 below.

CO₂+H₂O↔H₂CO₃↔HCO₃⁻+H⁺ [symbol] Equation 1

[symbol]

HCO₃⁻↔CO₃²⁻+H⁺ [symbol] Equation 2

[symbol]

Therefore, if carbon dioxide continues to dissolve in water above a certain amount, the increase in [H⁺] will decrease the pH, resulting in a state of dynamic equilibrium.

In order to make carbon dioxide more effectively soluble in water by enhancing the tendency for a static reaction in this case, the system passes seawater through ceramic particles comprising oxides, hydroxides or carbon oxides of alkaline earth metals as described above to produce a scrubber wash water with an enhanced alkalinity. When the scrubber wash water with an enhanced alkalinity is supplied to the carbon dioxide scrubber 300, the tendency of the scrubber wash water to dissolve carbon dioxide and increase [H+] upon gas-liquid contact with the exhaust gas is increased, and the carbon dioxide contained in the exhaust gas can be more effectively dissolved in the scrubber wash water. As such, the system can efficiently capture and remove carbon dioxide contained in the exhaust gas with a relatively simple process.

The scrubber wash water may be supplied in such a way that it is sprayed through a spray nozzle. In this case, the contact area of the scrubber wash water with the exhaust gas flowing inside the carbon dioxide scrubber 300 may be increased to further improve the capture efficiency of carbon dioxide. In addition, a packing layer may be further inserted inside the carbon dioxide scrubber 300 to increase the area of gas-liquid contact during gas-liquid contact.

Referring to FIG. 2, the system may further comprise an exhaust outlet 320 associated with the carbon dioxide scrubber 300, through which the carbon dioxide-reduced exhaust can be exhausted to the outside.

Also referring to FIG. 2, the system may further comprise a byproduct storage tank 330 for collecting and storing reaction byproducts discharged from the carbon dioxide scrubber 300, and a byproduct outlet 340 connected to the byproduct storage tank 330 for discharging the reaction byproducts to the sea.

There has been the problem that the captured carbon dioxide on a ship had to be loaded and kept on board with the conventional systems. Those systems are difficult to be installed and operated in a space-constrained environment, and also require excessive energy.

The proposed system captures carbon dioxide using the scrubber wash water described above, and may discharge the reaction byproducts from the carbon dioxide scrubber 300 into the sea, thereby facilitating better installation and operation in a space-constrained environment, as well as saving considerable amount of energy.

As described above, the scrubber wash water has an improved alkalinity and is stored in seawater in the form of carbonate ions and bicarbonate ions through an acid-base reaction with carbon dioxide, which has the advantage of greatly helping to prevent ocean acidification when discharged into the ocean. Due to the rapid increase in atmospheric carbon dioxide in recent years due to industrial development, the partial pressure of carbon dioxide in the ocean continues to increase, resulting in an increase in hydrogen ions. The increase in hydrogen ions in seawater inhibits the growth of marine life such as microplankton, crustaceans, coral reefs, etc. by re-dissolving and inhibiting the production of calcium carbonate, which constructs the skeletal structure of them. The imbalance of the ecological environment in the lower layers of the marine ecosystem has a significant impact on the environment, suggesting mass extinction. The present invention can not only reduce carbon dioxide in the atmosphere through a carbon dioxide scrubber, but at the same time, by discharging the reaction by-products with improved alkalinity into the sea, it can actively provide carbonate ions and bicarbonate ions so that they can act as a base to receive hydrogen ions dissolved in the atmosphere and reduce ocean acidification.

The carbon dioxide reduction system may be installed on a marine vessel or at an aquaculture plant.

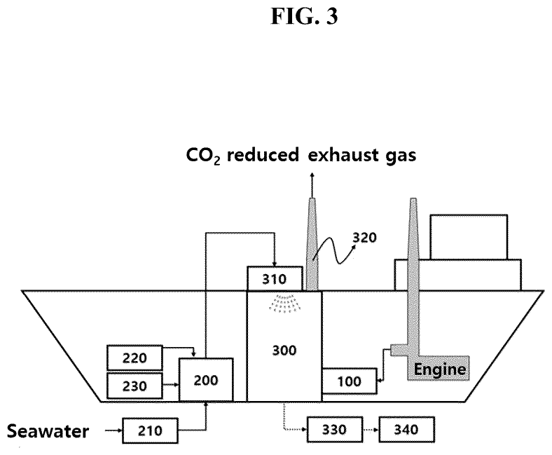

FIG. 3 describes a carbon dioxide reduction system for ships, according to still another embodiment.

Referring to FIG. 3, the system may further comprise a scrubber wash water generator 200, and a seawater inlet 210 connected to the scrubber wash water generator 200. In some cases, it may further comprise a ceramic particle storage 220 connected to the scrubber wash water generator 200 and periodically supplying ceramic particles to the scrubber wash water generator 200. It may further comprise an accelerator inlet 230 that is connected to the scrubber wash water generator 200 to input an accelerator comprising an oxide, hydroxide, or carbon oxide of an alkali metal into the scrubber wash water generator 200. When an accelerator comprising an oxide, hydroxide, or carbon oxide of an alkali metal is supplied to the scrubber wash water generator 200 via the accelerator inlet 230, the cleaning effect of the scrubber wash water may be improved.

As a result, the system can more efficiently capture and remove carbon dioxide contained in exhaust gases while occupying minimal space. Accordingly, it has the advantages of efficiently reducing carbon dioxide contained in exhaust gases, eliminating the necessity to prepare for a separate sealed container storing the captured carbon dioxide, improving space utilization in the space-limited environment, and reducing energy requirements.

In the detailed description above, only some exemplary embodiments have been described. However, the invention should not be understood to be limited to the specific embodiments described in the detailed description, but rather to include all variations, equivalents and substitutes within the spirit and scope of the invention as defined by the claims.
exhaust gas inlet 100
scrubber wash water generator 200
carbon dioxide scrubber 300
scrubber wash water supply 310

What is claimed is:

1. A carbon dioxide reduction system for capturing and removing carbon dioxide, installed on a ship or an offshore plant, to be connected to an exhaust outlet of a combustion engine discharging exhaust gas, comprising:
an exhaust gas inlet configured to receive the exhaust gas discharged from the combustion engine;
a scrubber wash water generator configured to store ceramic particles containing oxides, hydroxides, or carbonates of alkali metals, and to convert seawater into scrubber wash water through a reaction with the ceramic particles;
a carbon dioxide scrubber configured to receive the exhaust gas from the exhaust gas inlet and to reduce carbon dioxide; and
a scrubber wash water supply configured to supply scrubber wash water received from the scrubber wash water generator to the carbon dioxide scrubber to make the scrubber wash water and the exhast gas contact.

2. The carbon dioxide reduction system of claim 1, wherein
the scrubber wash water supply is further configured to be installed inside the carbon dioxide scrubber on an upstream side of the carbon dioxide scrubber and to spray the scrubber wash water in such a way that it is sprayed through a spray nozzle.

3. The carbon dioxide reduction system of claim 1, further comprising:
a byproduct storage tank configured to collect and to store reaction byproducts discharged from the carbon dioxide scrubber to enhance the efficiency of the reduction.

4. The carbon dioxide reduction system of claim 1, wherein the ceramic particles comprise at least one selected from the group consisting of CaCO₃, MgCO₃, CaO, MgO, Ca(OH)₂, and Mg (OH)₂.

5. The carbon dioxide reduction system of claim 1, wherein
the ceramic particles have an average particle size of 1 to 5,000 μm.

6. The carbon dioxide reduction system of claim 1, wherein
the scrubber wash water generator further comprises an accelerator inlet configured to receive an accelerator comprising an oxide, hydroxide, or carbon oxide of an alkali metal.

7. The carbon dioxide reduction system of claim 1, further comprising:
a ceramic particle storage configured to store the ceramic particles, and to be connected to the scrubber wash water generator such that the stored ceramic particles are periodically fed into the scrubber wash water generator.

8. The carbon dioxide reduction system of claim 1, further comprising:
a byproduct outlet configured to be connected to the byproduct storage tank, and to discharge the reaction byproduct into the ocean.

9. The carbon dioxide reduction system of claim 1, wherein The scrubber wash water has a pH of between pH 9.5 and 14.0.
